(19) United States
(12) Patent Application Publication
(10) Pub. No.: US 2022/0046080 A1
(43) Pub. Date: Feb. 10, 2022

(54) SYSTEMS AND METHODS FOR SHARED ACCESS AMONG HOST INFORMATION HANDLING SYSTEM AND MULTIPLE CLIENT INFORMATION HANDLING SYSTEMS VIA MANAGEMENT CONTROLLER

(71) Applicant: Dell Products L.P., Round Rock, TX (US)

(72) Inventors: Shine KA, Bangalore (IN); Tharakarama RAJU, Bangalore (IN); Rajeshkumar Ichchhubhai PATEL, Bangalore (IN); Rama Rao BISA, Bangalore (IN)

(73) Assignee: Dell Products L.P., Round Rock, TX (US)

(21) Appl. No.: 16/986,732

(22) Filed: Aug. 6, 2020

(51) Int. Cl. H04L 29/08; G06F 9/455; G06F 3/06

(52) U.S. Cl. CPC H04L 67/08; G06F 9/45508; G06F 3/0673; G06F 3/0644; G06F 3/0604

(57) ABSTRACT

An information handling system may include a processor, a management controller configured for out-of-band management of the information handling system and further configured to emulate non-transitory computer readable media of the management controller as an emulated mass storage device to an operating system executing on the processor and execute a server application to expose the emulated mass storage device to one or more client information handling systems communicatively coupled to the management controller via a network.

### TECHNICAL FIELD

The present disclosure relates in general to information handling systems, and more particularly to methods and systems for sharing access among a host information handling system and multiple client information handling systems via a management controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include a management controller configured to provide out-of-band management facilities for management of the information handling system. Such management controller may couple to a network, and may be accessed via a remote client also coupled to the network. Thus, by executing a virtual console management application on the remote client, an administrator may manage the information handling system on the virtual console via the management controller.

In some instances, real-time transfer of files between the information handling system and remote client may be desirable, for debugging and other uses. Further, it may be desirable to enable file sharing among multiple remote clients and the information handling system. However, an information handling system may have separate isolated networks for management and data. Accordingly, access to the information handling system from the remote client may not be possible other than through the management controller. In existing approaches, management controllers do not include options that allow a user to transfer files between an information handling system and a remote client and among remote clients and an information handling system.

### SUMMARY

In accordance with the teachings of the present disclosure, the disadvantages and problems associated with file transfer between an information handling system and remote management clients of the information handling system may be reduced or eliminated.

In accordance with embodiments of the present disclosure, an information handling system may include a processor, a management controller configured for out-of-band management of the information handling system and further configured to emulate non-transitory computer readable media of the management controller as an emulated mass storage device to an operating system executing on the processor and execute a server application to expose the emulated mass storage device to one or more client information handling systems communicatively coupled to the management controller via a network.

In accordance with these and other embodiments of the present disclosure, a management controller configured for out-of-band management of an information handling system and may include non-transitory computer readable media and a processor configured to emulate the non-transitory computer readable media as an emulated mass storage device to an operating system executing on a host system of the information handling system and execute a server application to expose the emulated mass storage device to one or more client information handling systems communicatively coupled to the management controller via a network.

In accordance with these and other embodiments of the present disclosure, a method, for use in an information handling system comprising a processor and a management controller configured for out-of-band management of the information handling system, may include emulating, by the management controller, non-transitory computer readable media of the management controller as an emulated mass storage device to an operating system executing on the processor and executing, by the management controller, a server application to expose the emulated mass storage device to one or more client information handling systems communicatively coupled to the management controller via a network.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for enabling shared access among a host information handling system and multiple client information handling systems via a management controller, in accordance with embodiments of the present disclosure; and

FIG. 2 illustrates a block diagram of another example system for enabling shared access among a host information handling system and multiple client information handling systems via a management controller, in accordance with embodiments of the present disclosure.

### DETAILED DESCRIPTION

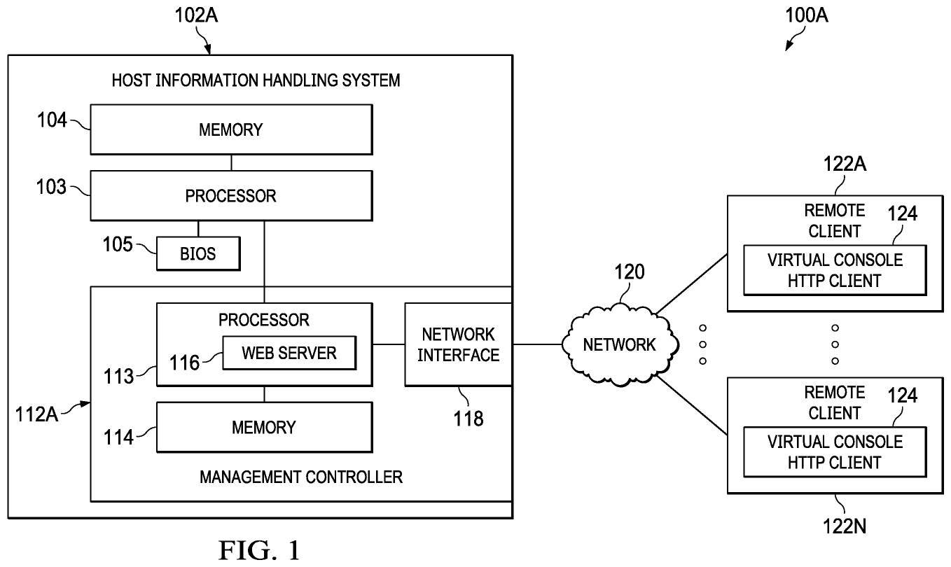

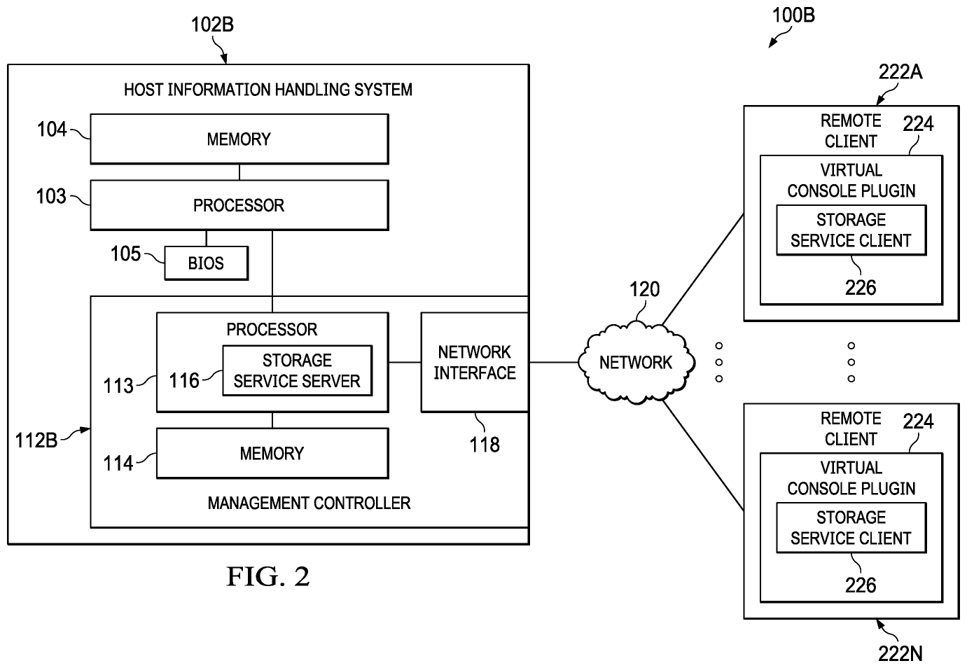

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100A for enabling shared access among a host information handling system 102A and multiple client information handling systems 122 via a management controller 112A, in accordance with embodiments of the present disclosure. As shown in FIG. 1, system 100A may include host information handling system 102A, a network 120, and a plurality of client information handling systems 122, which may also be referred to herein as remote clients 122 (e.g. remote clients 122A through 122N).

In some embodiments, host information handling system 102A may comprise or be an integral part of a server. In other embodiments, host information handling system 102A may be a personal computer. In these and other embodiments, host information handling system 102A may be a portable information handling system (e.g., a laptop, notebook, tablet, handheld, smart phone, personal digital assistant, etc.). As depicted in FIG. 1, host information handling system 102A may include a processor 103, a memory 104 communicatively coupled to processor 103, a basic input/output (BIOS) system 105 communicatively coupled to processor 103, and a management controller 112A communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of host information handling system 102A.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to host information handling system 102A is turned off.

BIOS 105 may be communicatively coupled to processor 103 and may include any system, device, or apparatus configured to identify, test, and/or initialize information handling resources of host information handling system 102A. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when host information handling system 102A is booted and/or powered on. As part of its initialization functionality, code for BIOS 105 may be configured to set components of host information handling system 102A into a known state, so that one or more applications (e.g., an operating system or other application programs) stored on compatible media (e.g., memory 104) may be executed by processor 103 and given control of host information handling system 102A.

Management controller 112A may be configured to provide out-of-band management facilities for management of host information handling system 102A. Such management may be made by management controller 112A even if host information handling system 102A is powered off or powered to a standby state. Management controller 112A may include a processor 113, memory 114, and an out-of-band network interface 118. In certain embodiments, management controller 112A may include or may be an integral part of a baseboard management controller (BMC), a remote access controller (e.g., a Dell Remote Access Controller or Integrated Dell Remote Access Controller), or an enclosure controller. In other embodiments, management controller 112A may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of host information handling system 102 or management controller 112A.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112A is turned off. Memory 114 may have stored thereon software and/or firmware which may be read and executed by processor 113 for carrying out the functionality of management controller 112A. In some embodiments, memory 114 may be a part of or may include a storage partition, such as a maser partition.

Network interface 118 may comprise any suitable system, apparatus, or device operable to serve as an interface between management controller 112A and/or one or more other information handling systems. Network interface 118 may enable management controller 112A to communicate using any suitable transmission protocol and/or standard. In these and other embodiments, network interface 118 may comprise a network interface card, or “NIC.”

In addition to processor 103, memory 104, BIOS 105, and management controller 112A, host information handling system 102A may include one or more other information handling resources.

Network 120 may comprise a network and/or fabric configured to couple host information handling system 102A and network share 122 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

A remote client 122 may comprise an information handling system, and may include any system, device, or apparatus configured to provide remote management facilities of host information handling system 102A via network 120. To perform such remote management functions, a virtual console 124 implemented as a Hypertext Transfer Protocol (HTTP) or Hypertext Transfer Protocol Secure (HTTPS) client may execute on a remote client 122.

In operation, a web server 116 may execute on processor 113 of management controller 112A. Whenever a virtual console session is active between a remote client 122 and information handling system 102A, management controller 112A may emulate memory 114 or a portion thereof as a mass storage device to an operating system executing on processor 103. In some embodiments, such emulated mass storage device may be a static partition from embedded Multi-Media Controller (eMMC) or a dynamic partition created from random access memory of management controller 112A.

Web server 116 may host the emulated mass storage device as a HTTP or HTTPS share, such that the share may be accessed via any HTTP/HTTPS client, such as virtual consoles 124 executing on remote clients 122. Using existing management controller 112A authentication, management controller 112A may expose a uniform resource locator (URL) to share the partition of memory 114 emulated as a mass storage device to HTTP/HTTPS clients communicatively coupled to management controller 112A via network 120. Accordingly, an administrator managing host information handling system 102A from a remote client 122 may launch the share either via a graphical user interface of management controller 112A or via virtual console 124.

Once the share connection to the emulated mass storage device is established, files may be shared among host information handling system 102A and/or one or more remote clients 122.

FIG. 2 illustrates a block diagram of another example system 100B for enabling shared access among a host information handling system 102B and multiple client information handling systems 222 via a management controller 112B, in accordance with embodiments of the present disclosure. The architecture and functionality of system 100B may be similar in many respects to that of system 100A, except as described below.

Notably, rather than implementing a web server 116, processor 113 of management controller 112B may execute a storage service server 216 (e.g., Network File Service, Common Internet File System, Network Block Device, or other suitable service or protocol). Also of note, each remote client 222 may execute a virtual console plug-in 224 which in turn may implement a storage service client 226.

In operation, whenever a virtual console session is active between a remote client 222 and information handling system 102B, management controller 112B may emulate memory 114 or a portion thereof as a mass storage device to an operating system executing on processor 103. In some embodiments, such emulated mass storage device may be a static partition from embedded Multi-Media Controller (eMMC) or a dynamic partition created from random access memory of management controller 112A.

Storage service server 216 may expose the emulated mass storage device to connected storage service clients 226 and expose a share link to share the emulated mass storage device over all connected storage service clients 226. Such sharing may not use existing management controller 112B authentication, but instead, remote clients 222 may need to use management controller 112B credentials to connect to a storage service server 216.

Once the share connection to the emulated mass storage device is established, files may be shared among host information handling system 102B and/or one or more remote clients 222.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a management controller configured for out-of-band management of the information handling system and further configured to:
emulate non-transitory computer readable media of the management controller as an emulated mass storage device to an operating system executing on the processor; and
execute a server application to expose the emulated mass storage device to one or more client information handling systems communicatively coupled to the management controller via a network.

2. The information handling system of claim 1, wherein the server application is a web server application that enables the one or more client information handling systems to access the emulated mass storage device via one of Hypertext Transfer Protocol and Hypertext Transfer Protocol Secure.

3. The information handling system of claim 1, wherein the server application is a web server application that enables the one or more client information handling systems to access the emulated mass storage device via a network storage protocol.

4. The information handling system of claim 3, wherein the network storage protocol comprises one of Network File Service, Common Internet File System, and Network Block Device.

5. The information handling system of claim 1, wherein the emulated mass storage device is a static partition of the non-transitory computer readable media.

6. The information handling system of claim 5, wherein the static partition comprises a partition of an embedded multi-media controller of the management controller.

7. The information handling system of claim 1, wherein the emulated mass storage device is a dynamic partition of the non-transitory computer readable media.

8. The information handling system of claim 7, wherein the dynamic partition comprises a partition of a random access memory of the management controller.

9. A management controller configured for out-of-band management of an information handling system and comprising:
non-transitory computer readable media; and
a processor configured to:
emulate the non-transitory computer readable media as an emulated mass storage device to an operating system executing on a host system of the information handling system; and
execute a server application to expose the emulated mass storage device to one or more client information handling systems communicatively coupled to the management controller via a network.

10. The management controller of claim 9, wherein the server application is a web server application that enables the one or more client information handling systems to access the emulated mass storage device via one of Hypertext Transfer Protocol and Hypertext Transfer Protocol Secure.

11. The management controller of claim 9, wherein the server application is a web server application that enables the one or more client information handling systems to access the emulated mass storage device via a network storage protocol.

12. The management controller of claim 11, wherein the network storage protocol comprises one of Network File Service, Common Internet File System, and Network Block Device.

13. The management controller of claim 9, wherein the emulated mass storage device is a static partition of the non-transitory computer readable media.

14. The management controller of claim 13, wherein the static partition comprises a partition of an embedded multi-media controller of the management controller.

15. The management controller of claim 9, wherein the emulated mass storage device is a dynamic partition of the non-transitory computer readable media.

16. The management controller of claim 15, wherein the dynamic partition comprises a partition of an random access memory of the management controller.

17. A method, in an information handling system comprising a processor and a management controller configured for out-of-band management of the information handling system, the method comprising:
emulating, by the management controller, non-transitory computer readable media of the management controller as an emulated mass storage device to an operating system executing on the processor; and
executing, by the management controller, a server application to expose the emulated mass storage device to one or more client information handling systems communicatively coupled to the management controller via a network.

18. The method of claim 17, wherein the server application is a web server application that enables the one or more client information handling systems to access the emulated mass storage device via one of Hypertext Transfer Protocol and Hypertext Transfer Protocol Secure.

19. The method of claim 17, wherein the server application is a web server application that enables the one or more client information handling systems to access the emulated mass storage device via a network storage protocol.

20. The method of claim 19, wherein the network storage protocol comprises one of Network File Service, Common Internet File System, and Network Block Device.

21. The method of claim 17, wherein the emulated mass storage device is a static partition of the non-transitory computer readable media.

22. The method of claim 21, wherein the static partition comprises a partition of an embedded multi-media controller of the management controller.

23. The method of claim 17, wherein the emulated mass storage device is a dynamic partition of the non-transitory computer readable media.

24. The method of claim 23, wherein the dynamic partition comprises a partition of an random access memory of the management controller.
